(19) United States
(12) Patent Application Publication
(10) Pub. No.: US 2022/0400782 A1
(43) Pub. Date: Dec. 22, 2022

(54) HOODED GARMENT WITH INSECT OR BUG MESH

(71) Applicant: Mark Anthony LINDSAY, Scarborough (CA)

(72) Inventor: Mark Anthony LINDSAY, Scarborough (CA)

(21) Appl. No.: 17/846,383

(22) Filed: Jun. 22, 2022

Related U.S. Application Data
(60) Provisional application No. 63/213,440, filed on Jun. 22, 2021.

(51) Int. Cl. A41D 1/02

(52) U.S. Cl. CPC A41D 1/02; A41D 2200/20

(57) ABSTRACT

The invention relates particularly to the addition of a mosquito mesh sewn as a lining inside the hooded section of clothing, which will provide an option to cover the face portion of the hoodie, jacket or hooded clothing. A fastener is attached to the free edge of the mesh to removably secure the free edge to a rear portion of the hood.

### FIELD OF THE INVENTION

The invention relates to a garment for the upper body, such as a hoodie or other item of clothing with a hood.

### BACKGROUND OF THE INVENTION

Many people enjoy wearing clothing with hoods. Conventional hooded clothing is a popular form of everyday fashion, and some even offer a full-time mesh head piece or full body coverage.

### SUMMARY OF THE INVENTION

The invention provides the wearer with a bug mesh attached as a lining inside the head part of hooded clothing (e.g., hoodies, jackets, etc.). It offers protection from annoyance or attack from flying insects, such as mosquitoes, and undesired environmental situations. It protects the face and the neck area or the wearer.

The invention provides an improvement on already existing clothing options by offering the inexpensive instant option to lower your mosquito mesh to protect your face whenever it's required. The necessity and need for this invention are apparent in many daily life situations. Take going on vacation or just going for a walk in the evening. What if you forgot to bring or put on bug protection spray? After a few minutes you find yourself been eaten alive by mosquitoes, and constantly harassed by different kind of flies. A mosquito mesh hoodie (or other item of clothing) offers the wearer the versatility to still maintain their sense of style and comfort, while protecting their face and head from attack.

Mesh is known to be included with other garments. However, unlike other garments, my invention takes a regular hoodie, jacket, or hooded garment, sews in mosquito mesh as a lining which is accessible by multiple buttons, snaps, zippers, or Velcro giving the user the option to open and use whenever they want.

My invention offers the user the option to access the mosquito mesh protection when needed. The lack of protection currently offered by wearing hoodies, jackets or hooded garments is not suitable for total enjoyment offered by venturing outdoors. The unpredictability with changes in the environment, and location requires the user to have a better face protective option.

The addition of a mesh attached inside as a lining provides the user with the option to cover and protect their face. Protection for your face when riding a bicycle, or jogging, taking a walk, sitting at the park or your backyard. Dust storms or strong blowing winds at a beach.

Other features and advantages of this invention is protection from environmental situations while in different locations.

### BRIEF DESCRIPTION OF THE DRAWINGS

FIG. 1 is a front view of a garment (e.g., hoodie) with a mesh that provides protection to the face and neck area of the body, when the mesh is deployed.

FIG. 2 is a side view of the garment with mesh of FIG. 1.

FIG. 3 is another side view of the garment with mesh of FIG. 1 with the wearer omitted from view for sake of clarity.

FIG. 4 is another side view of the garment with mesh of FIG. 1 with the wearer omitted from view for sake of clarity and with the mesh stowed inside the hood (i.e., behind the wearer's head).

FIG. 5 is a front view of the hood of FIG. 1 showing buttons, snaps, or other fastener to allow the stowing of the mesh, as shown in FIG. 4.

FIG. 6 show various views of buttons, snaps, or other fastener to stow the mesh inside the hood.

FIG. 7 is a closeup view of buttons, snaps, or other fastener and attachment of such to the material of the garment.

### DETAILED DESCRIPTION OF THE INVENTION

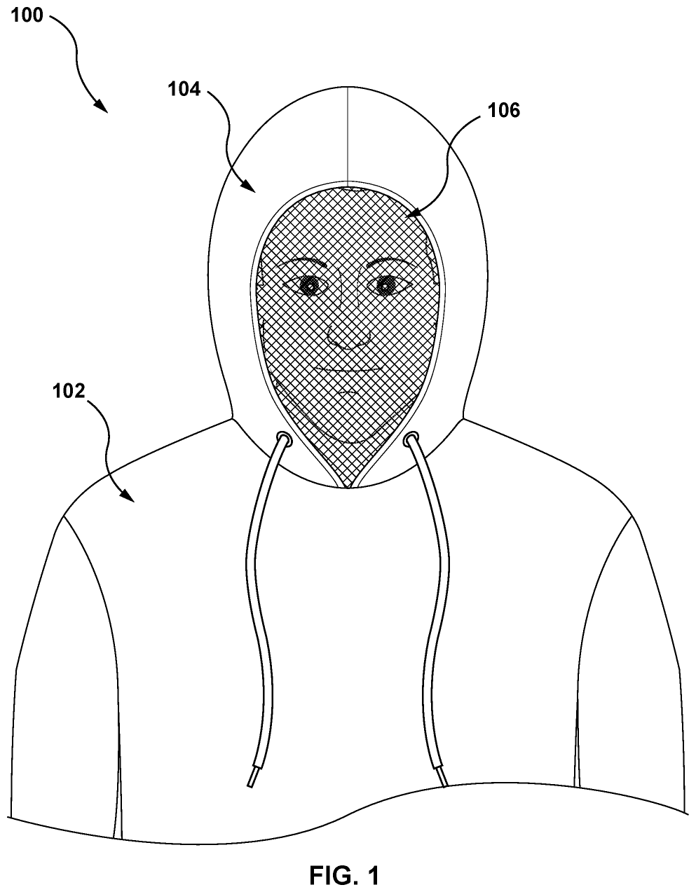

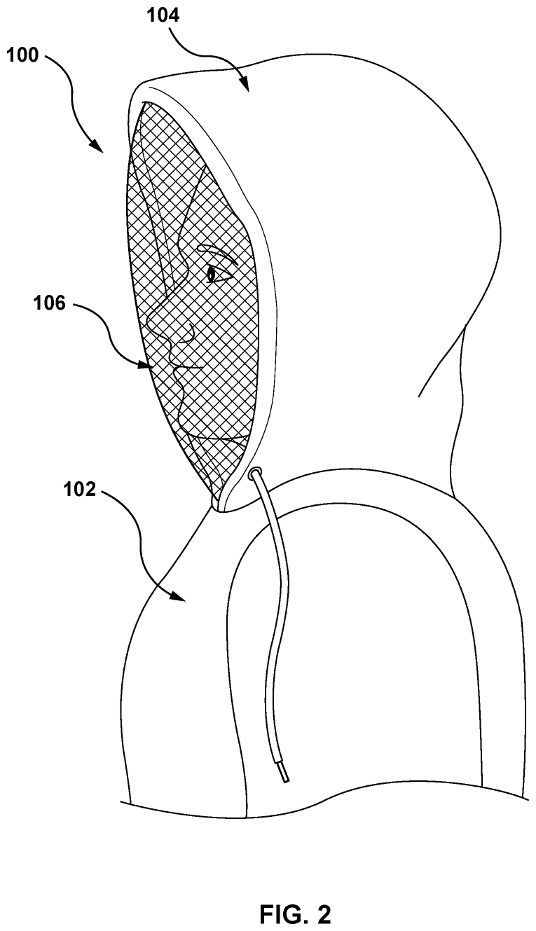

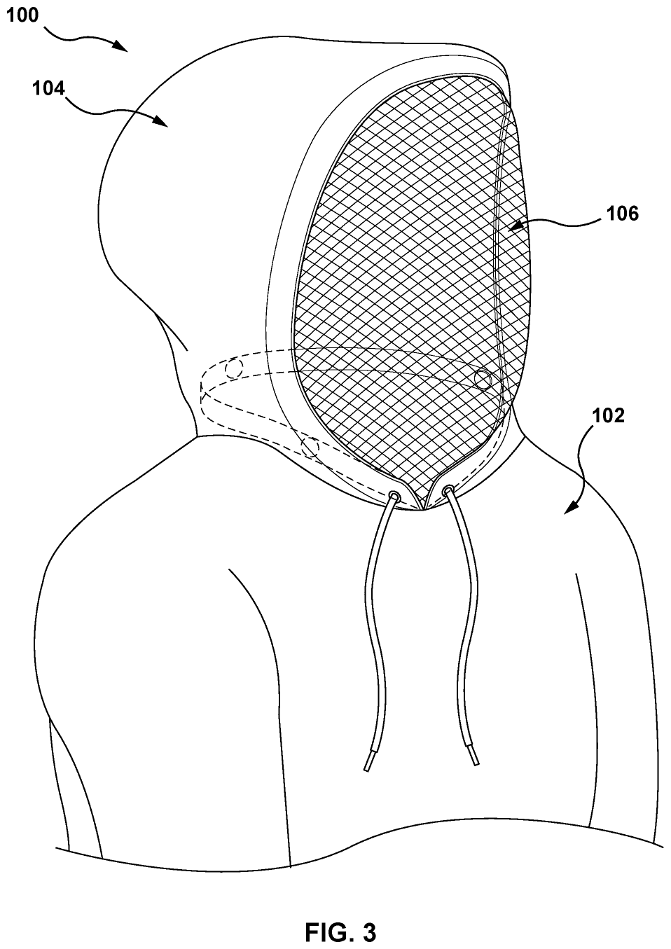

FIGS. 1-3 show a garment 100 with a body 102, hood 104, and mesh 106 attached to the hood 104. The garment 100 may be a hoodie, jacket, or similar item of clothing.

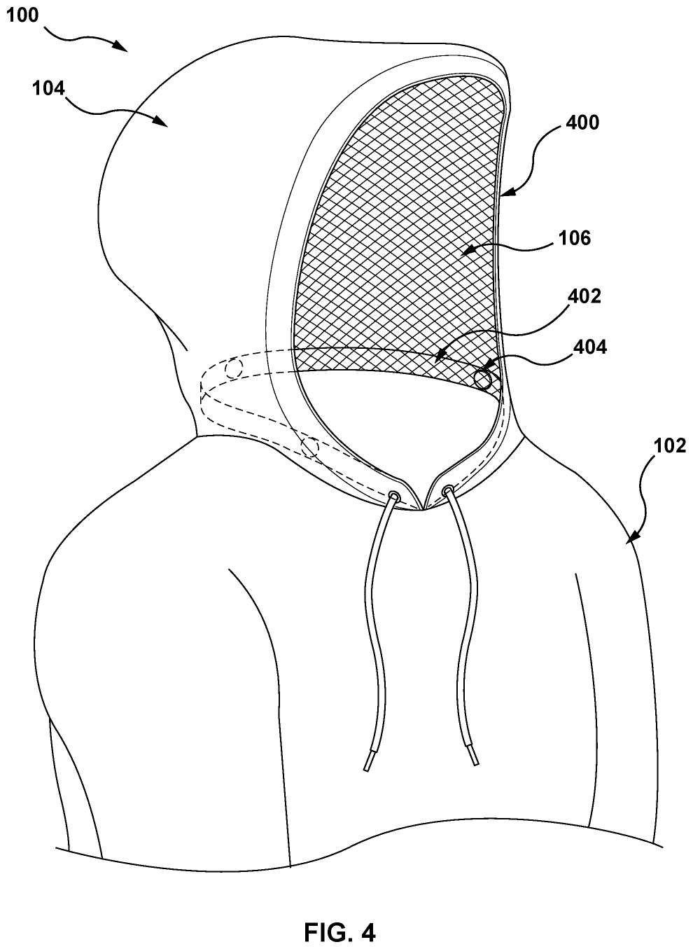

With reference to FIG. 4, the mesh 106 is sewn or attached directly into the hooded portion 102 at edge 400. A bottom edge 402 of the mesh 106 is not sewn and is detachable from the hood 104. The mesh 106 is accessible by releasing a fastener or fasteners 404, such as snaps, Velcro, zippers or buttons, which detachable secure the bottom edge 402 of the mesh 106 to the hood 104. The mesh size may be 0.6 to 1.2 millimetres to offer protection from different sizes of flying insects. The mesh 106 is made from cotton, polyethylene, polyester, polypropylene, nylon, or other materials. The mesh 106 is a see-through material. The mesh 106 may include a perimeter of non-mesh fabric or material to facilitate sewing and/or attachment.

The mesh 106 is cut and altered to match the original dimensions of any size hoodie or jackets hoods.

The mesh 106 is light enough to not cause overheating of the wearer or take away from the effectiveness and styling of the hoodie or jacket. The mesh 106 enhances the function of hoodie or jacket.

When stowed, i.e., when the fasteners 404 are connected, the mesh 106 may situated behind the wearer's head and may act as a lining for the hood 104.

The mesh 106 that is shaped and sized to cover the wearer's face and may extend into the neck of the garment to block insects/bugs or other annoyances from intruding into the hood. The mesh 106 includes an attached edge 400 (mainly at top and sides) that may be sewn to the hood 104. The mesh includes a free edge 402 (mainly at bottom) that is configured to allow the mesh to be selectively deployed in front of a wearer's face (FIGS. 1-3) and stowed behind the wearer's head (FIG. 4). A fastener or set of fasteners 404 is attached to the free edge 402 of the mesh 106 to removably secure the free edge 402 to an inner rear portion of the hood 104.

The mesh 106 has a donned or deployed configuration, shown in FIGS. 1-3. The mesh 106 also has a stowed configuration, shown in FIG. 4, where the fasteners 404 secure the mesh 106 behind the wearer's head. The mesh may thus act like a lining to the hood 104 and be out of view and out of the way of the wearer, so as to not cause distraction or annoyance when not in use.

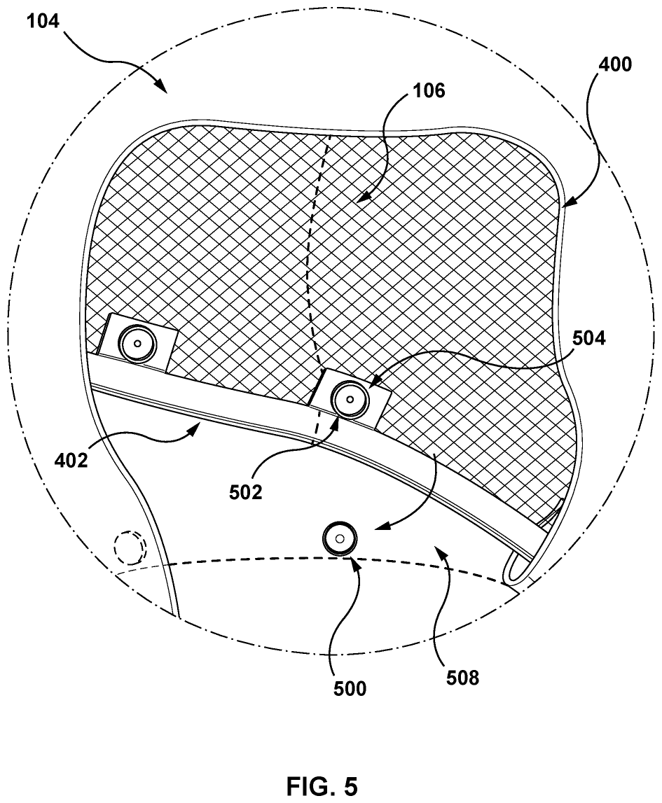

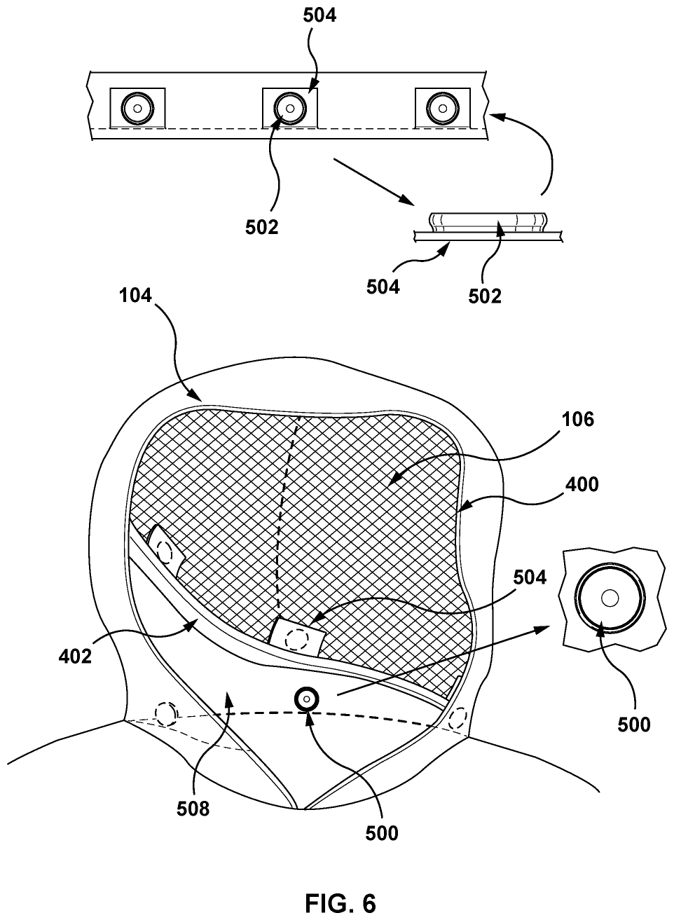

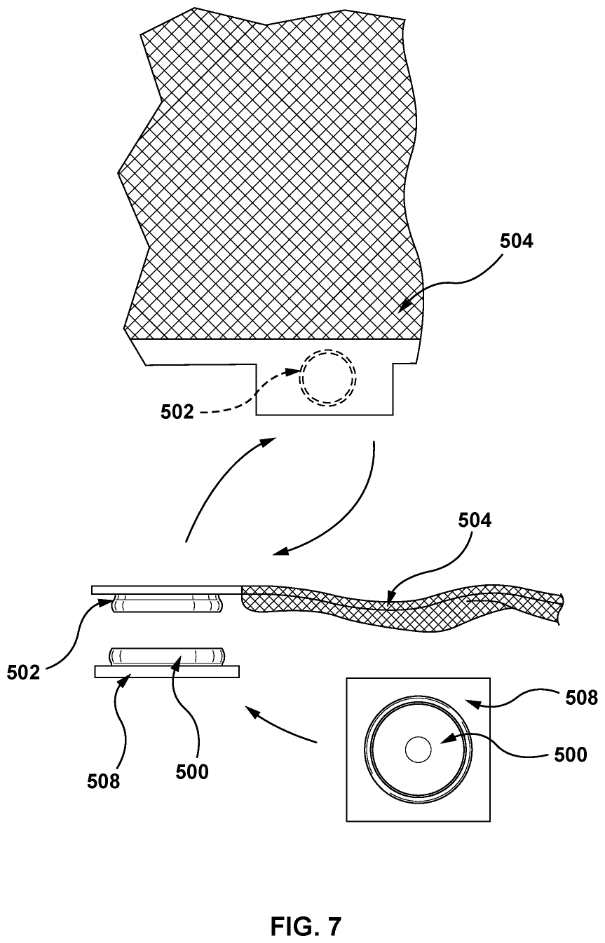

FIGS. 5-7 show various important aspects of the invention, such as flaps or tabs of fabric extending from the edge of the mesh to carry fastener parts that mate with complementary parts sewn into the rear neck area of the hood.

As shown in FIGS. 5-7, an example fastener 404 includes a snap 500, 502 that includes a female (or male) snap part 500 attached to the inner side at the neck portion 508 of the hood 104 and a complementary male (or female) snap part 502 attached to a flap 504 at the free edge 402 of the mesh 106.

The snap part 500 attached to the inner side at the neck portion 508 of the hood 104 may be attached to a carrier, such as a piece or loop of fabric that is sewn to the hood 104. A loop of fabric may be flattened, with one side sewn to the hood 104 and the other side carrying the snap part 500. In other examples, the snap part 500 is directly attached to the neck portion 508 of the hood 104.

The flap 504 that carries the snap part 502 may be slightly larger than the snap part 502. The flap 504 may be attached at (or be integral with) the free edge 402 of the mesh 106. The flap 504 allows easy manipulation of the snap part 502 to engage with the complementary snap part 500 at the hood 104. That is, the wearer can position the flap 504 to engage the snap parts 500, 502 with minimal movement of the free edge 402 of the mesh 106 and neck of the hood 104. This may allow for easy engagement of the snap parts 500, 502 by feel, without having to look at the snap parts 500, 502. This may allow the mesh 106 to be stowed (and deployed) easily and without having to remove the garment.

In view of the above it should be apparent that a garment, such as a hoodie or jacket, may be provided with a stowable and deployable mesh to protect the wearer's face from insects and other annoyances or safety concerns. The mesh may be easily stowed behind the wearer's head using a fastener, so that the garment appears like any other garment when the mesh is stowed.

The above-described embodiments of the invention are intended to be examples of the present invention and alterations and modifications may be effected thereto, by those of skill in the art, without departing from the scope of the invention.

I claim:

1. A garment comprising:
a hood; and
a mesh including:
an attached edge attached to the hood;
a free edge configured to allow the mesh to be selectively deployed in front of a wearer's face and stowed behind the wearer's head; and
a fastener positioned at the free edge of the mesh to removably secure the free edge to a rear portion of the hood, wherein the fastener is configured to attach the free edge of the mesh to the rear portion of the hood when the mesh is stowed behind the wearer's head, and wherein the fastener is configured to detach the free edge of the mesh from the rear portion of the hood when the mesh is deployed in front of the wearer's face.

2. The garment of claim 1, further comprising a flap of fabric positioned at the free edge of the mesh, wherein the flap of fabric carries part of the fastener to attached to a complementary part of the fastener that is attached to an inside of the rear portion of the hood.

3. The garment of claim 1, wherein the attached edge comprises sides and a top of the mesh and the free edge comprises a bottom of the mesh.

4. The garment of claim 1, further comprising a plurality of such fasteners spaced along the free edge of the mesh.

5. The garment of claim 1, wherein the fastener comprises a snap.

6. The garment of claim 1, further comprising a body to which the hood is attached to form a hoodie.

7. The garment of claim 1, further comprising a body to which the hood is attached to form a jacket.
